(19) United States
(12) Patent Application Publication
(10) Pub. No.: US 2025/0078465 A1
(43) Pub. Date: Mar. 6, 2025

(54) GRID-BASED PROCESSING OF MEASUREMENT DATA FOR CLASSIFYING AND DETERMINING PROPERTIES OF OBJECTS IN AN AREA

(71) Applicant: Robert Bosch GmbH, Stuttgart (DE)

(72) Inventors: Alexander Bartler, Villingen-Schwenningen (DE); Bastian Bischoff, Gerlingen (DE); Csaba Domokos, Simmozheim (DE); Daniel Niederloehner, Stuttgart (DE); Kilian Rambach, Stuttgart (DE); Maurice Quach, Ditzingen (DE); Michael Ulrich, Stuttgart (DE); Patrick Ziegler, Waiblingen (DE); Ruediger Jordan, Stuttgart (DE); Sascha Braun, Eningen Unter Achalm (DE)

(21) Appl. No.: 18/798,919

(22) Filed: Aug. 9, 2024

(30) Foreign Application Priority Data
Sep. 6, 2023 (DE) 10 2023 208 621.2

(51) Int. Cl. G06V 10/764; G06V 10/77; G06V 10/82; G06V 20/52

(52) U.S. Cl. CPC G06V 10/764; G06V 10/7715; G06V 10/82; G06V 20/52

(57) ABSTRACT

A method for processing measurement data from a surveillance of an area into classification scores with respect to a given classification and/or properties of objects in the area. The method includes: providing a point cloud of measurement data that assigns, to each of a plurality of points in space, measurement values of at least one quantity; providing an input grid with a plurality of cells; assigning, based on the point cloud, values of the at least one measurement quantity, and/or of at least one work product derived therefrom, to each cell of the input grid; and processing, by a task neural network, the input grid into an output grid whose cells carry classification scores and/or properties of objects as values.

### CROSS REFERENCE

The present application claims the benefit under 35 U.S.C. § 119 of German Patent Application No. DE 10 2023 208 621.2 filed on Sep. 6, 2023, which is expressly incorporated herein by reference in its entirety.

### FIELD

The present invention relates to the processing of measurement data in the form of point clouds that has been gathered by surveillance of an area. The result of this processing includes classification scores and/or other properties of objects in the area.

### BACKGROUND INFORMATION

In many applications where an area or volume in space is monitored by means of one or more sensors, a representation of the area that comprises information about objects in the area is needed. In particular, it needs to be determined which parts of the monitored area are occupied by objects of which types, and which other properties these objects have.

Some physical modalities for monitoring the area, such as radar and lidar, produce measurement data in point clouds. Point clouds assign, to each point contained therein, values of measurement data. The points can be anywhere in space and do not need to form a regular grid, or even a contiguous area. The measurement data are projected onto such a regular grid and then processed further into the sought classification scores and/or other properties.

### SUMMARY

The present invention provides a method for processing measurement data from the surveillance of an area into information pertaining to objects in this area. This information includes classification results with respect to a given classification, and/or other sought properties of the objects.

According to an example embodiment of the present invention, the method starts from a point cloud of measurement data. This point cloud assigns, to each of a plurality of points in space, measurement values of at least one quantity. The points may be specified by any suitable set of coordinates, such as Cartesian coordinates or polar coordinates. The coordinate system is typically determined by the type of measurement that is being performed. For example, in radar measurements, a point may be characterized by a distance, an azimuth angle and an elevation angle. In particular, each point in the point cloud may represent a place on an object from which a signal that gives rise to the measurement value originates.

A point cloud is a list of unordered points, that is, the order is irrelevant. Each point is characterized by certain properties, e.g., its radar cross-section (RCS) or the radial speed compensated for by the radar's own motion.

Furthermore, an input grid with a plurality of cells is provided. Each cell denotes a certain volume in space. The resolution with which the area is monitored determines the volume of each cell. The grid may be defined as a three-dimensional grid or as a two-dimensional grid. In particular, a two-dimensional grid defined in one plane may be regarded as a three-dimensional grid with cells that extend, from this plane, to infinity in a direction perpendicular to this plane.

Based on the point cloud, values of the at least one measurement quantity, and/or of at least one work product derived therefrom, are assigned to each cell of the input grid. This may be regarded as a projection of the point cloud onto the input grid. This projection may be performed in any suitable manner. For example, measurement values that are attached to points in each cell may be aggregated to a value that is then assigned to the cell. There are many possibilities for doing so. For example, the measurement values may be added, and the sum may be divided by the number of contributing points. Measurement values may also be weighted differently in the sum depending on where in the cell the points are located.

According to an example embodiment of the present invention, a task neural network processes the input grid into an output grid whose cells carry classification scores and/or properties of objects. This output grid need not be identical to the input grid. In particular, the output grid may be coarser than the input grid, that is, it may contain fewer cells. The classification scores and/or properties of objects also imply a hypothesis as to whether an object is present in a certain area corresponding to the cell of the output grid, or whether the cell of the output grid is free of objects. The task neural network may produce the output grid in one go, but it may also produce an intermediate grid along the way during the processing of the input grid into the output grid. In particular, if the architecture of the task neural network is composed of two distinct parts, the first part may produce the intermediate grid, and the second part may process the intermediate grid onwards to the output grid.

In particular, the properties of objects may comprise one or more properties that characterize Oriented Bounding Boxes, OBB, for objects. Examples for these properties include existence probability, size, orientation and object type. That is, when predicting OBBs, classification (here: with respect to object type) and regression (here: with respect to size and orientation) may be combined. Existence probability may be determined as a numeric value by regression as well. Alternatively, it may be classified in a binary manner whether the OBB is likely to exist or not.

In the course of the method, the input grid, the output grid, and/or the intermediate grid that arises during the processing of the input grid into the output grid, is modified.

According to an example embodiment of the present invention, for each cell of the respective grid, based on the coordinates of the points in the point cloud, it is determined which cells are occupied by objects and which are not. If at least one point of the point cloud is within a cell, this cell is determined to be occupied by an object. If the cell is free of points of the point cloud, the cell is deemed to be unoccupied. In other words, if no signal that gives rise to a measurement value emanates from an object anywhere within a cell, then the cell may be deemed free of objects.

To modify the respective grid, values assigned to unoccupied cells in the respective grid are modified to a neutral value in the context of the respective grid.

It was found that, even if there is in fact no object in a cell, various stages of the processing may result in one or more cells being assigned classification scores or other properties of objects that are not fully in agreement with the absence of an object. For example, if the projection of the point cloud of measurement data onto the input grid is performed by a neural network, small but non-zero values of the at least one measured quantity may be assigned to cells of the input grid that are in fact free of objects. During the later processing into the output grid, these values may be amplified and give rise to unoccupied cells in the output grid being assigned values of classification scores and/or properties that indicate the presence of an object where there is none. For example, if the obtained classification scores and/or properties of objects are assembled into a representation of a vehicle environment, “ghost” objects may appear. The trajectory planning of the vehicle, or another vehicle assistance system, may then react to these “ghost” objects in an inappropriate manner. For example, an automated vehicle may suddenly brake or initiate an evasion maneuver to avoid a collision with the “ghost” object.

Likewise, an undesirable “filling in” of unoccupied grid cells with information that may be perceived as indicating the presence of an object may also occur when the task neural network processes the input grid into the output grid. An intermediate grid that is computed along the way may be affected by this “filling in” as well.

By modifying the input grid, the intermediate grid, and/or the output grid, to contain neutral values for unoccupied cells, the respective grid is tuned to be consistent with the knowledge from the point cloud as to where in space objects reside. That is, the measurement values from the point cloud are processed further and enhanced until the sought classification scores and/or properties of objects result, but the initially gained knowledge where objects are at all in space is kept as it is. The presence or absence of signals emanating from objects in a certain cell is taken as the most reliable indicator regarding the presence or absence of objects.

Herein, it depends on the concrete application at hand which values of classification scores, and/or other properties, may be considered neutral values. For example, if the classification scores all relate to certain types of objects, then all-zero classification scores may be neutral values indicating that no object is present. However, if there is another dedicated class for object-free background, then a one-hot classification score for this background class may be considered the neutral value. In another simple example, where the finally derived property comprises the temperature of an object, the neutral value is not the freezing point or even absolute zero. Rather, the temperature of an object-free cell should blend in with the ambient temperature.

Thus, in a particularly advantageous embodiment of the present invention, a value that pertains, in the context of the respective grid, to an object-free background is chosen as the neutral value.

Also, what is to be considered a neutral value may further depend on a loss function (objective function) that is used as a source of feedback during training of the task neural network.

The modifying of values for unoccupied cells to neutral values can be termed “occupancy masking”. In this way, the neural network is focused only on the occupied cells (that contain points) during training. Also, the neural network can only output bounding boxes in occupied cells. This can be beneficial in situations where the point cloud is sparse. For example, when the radar sensor outputs a low number of points or when considering far away objects.

Occupancy masking does not modify the network architecture. It only modifies the output class probabilities and regression parameters. It does so during both training and inference. Thus, it affects both the model training and the model behavior during inference.

Occupancy masking takes as input an output grid of object hypotheses and masks the grid based on the input point cloud. The information in occupied cells stay identical while the information in unoccupied cells is masked.

The abstract features extracted from the point cloud can then be processed using a backbone convolutional neural network, which processes the data on multiple spatial scales. For the concrete implementation, a backbone consisting of a residual network and a feature pyramid network that is able to extract features for the different output resolutions of the 2D grids in the backbone may be used.

Since an object can span several grid cells, the generated object hypotheses may be filtered by voting. This is done by non-maximum suppression. For each object, spatial superimposed object hypotheses may be filtered according to the one with the highest object probability. The filtered object hypotheses in the form of an OBB are then the output of the detection network.

Advantages of the method of the present invention include:
Unoccupied cells do not result in predicted bounding boxes as their output is masked by occupancy masking. This enforces that detections are present only in occupied locations (the model does not make random guesses in empty space).
Better detection performance is expected as the network training only takes occupied cells into account.
It behaves better when point cloud is sparse such as with radar sensor outputting sparse point clouds or when working at far distances.
Occupancy masking reduces the complexity of the post-processing steps in the object detection pipeline. Indeed, it removes bounding box predictions from unoccupied grid cells and thus reduces the number of predicted bounding boxes. Non-maximum suppression is often applied to remove duplicate boxes and scales with the number of boxes. Thus, its complexity is much reduced.

The method brings strong benefits with limited drawbacks and could be used in a large number of products.

It depends on the concrete application, and in particular on what needs to be guaranteed in this application, where the occupancy masking is best applied. For example, applying occupancy masking at the output of the task neural network guarantees that the output will be free of objects in unoccupied cells. On the other hand, applying occupancy masking after the initial grid projection reduces the computational complexity of the further calculations as early as possible.

In a further advantageous embodiment of the present invention, the given classification comprises, in addition to classes associated with objects, a class associated with an object-free background. In this manner, the absence of an object may be distinguished from, e.g., the result of the classification being completely inconclusive, or other conditions that might give rise to all-zero classification scores. For example, if a completely new type of object appears in a scenery, but the given classification only comprises a limited set of classes relating to known objects, both this completely new object and object-free background might receive all-zero classification scores.

In a further particularly advantageous embodiment of the present invention, values assigned to unoccupied cells are further modified according to values in one or more neighboring cells. In this manner, artifacts created by a hard boundary between values that are kept as they are and values that are modified to neutral values may be suppressed. This further modification may also be regarded as “padding”.

For example, a softening algorithm may be applied to at least one boundary between a first region comprising occupied cells and a second region comprising unoccupied cells. One exemplary way of doing this is applying max-pooling to the grid with a kernel size of, e.g., 3. This is equivalent to setting all empty cells that are neighboring occupied cells (including diagonals) as occupied cells. In another example, in response to determining that a cell is occupied, neighboring cells may be treated as being occupied as well.

The padding operation can be applied on the input grid or output grid. The input grid is the finest scale of the network after grid projection of the point cloud. The output grid is the scale at which the detection heads operate which is typically coarser than the input grid's scale. The output grid is obtained by downscaling the input grid to the scale of the corresponding detection head. Experiments have shown that output padding with a kernel of size 3 significantly improves performance across settings.

In theory, the input grid is not necessary as the output grids could be directly computed from the point cloud. However, it is computationally efficient to compute the output grid from the input grid. Indeed, the input grid is available anyway as soon as the point cloud is projected to a grid. This is why having both padding on input occupancy grids and output occupancy grids may be advantageous.

In a further particularly advantageous embodiment of the present sent invention, the values in the intermediate grid and/or output grid are chosen to represent logits that are precursors for classification scores. In this manner, if the network is configured to perform the final processing of the logits into classification scores differently during training and during inference (i.e., use of the trained network), the modification to avoid “ghost” objects needs to be applied only once and can then be used both during training and during inference. For example, a network that uses a nonlinear, non-differentiable activation function to determine the final output of neurons during inference may use a differentiable approximation of this activation function during training in order to allow back-propagation of gradients of a loss function (objective function) that is used for optimizing the parameters of the network.

In a particularly advantageous embodiment of the present invention, during training of the task neural network, computation of classification scores from logits is amalgamated with computation of the value of a loss function that rates these classification scores. This avoids numerical instabilities due to very small or very large values. That is, rather than computing the very small or very large classification score and then plugging this into the computation of the loss function, the classification scores and the value of the loss function are computed in one go. The amalgamated computation is one example of how classification scores may be computed differently during training on the one hand, and during inference on the other hand.

Typically, the class probabilities are obtained by applying the softmax operation to the unnormalized outputs of the neural network for each cell, also called the logits. For example, when the logits of a grid cell are [1, 0, 0], then the corresponding probabilities are softmax ([1, 0, 0])=[0.57, 0.21, 0.21].

Commonly used loss functions for classification (such as cross entropy and focal loss) are usually applied to the logits directly instead of the post-softmax probabilities. This enables more numerically stable formulations of these loss functions.

This is why a new specialized method to set the class probabilities in unoccupied cells is advantageous. This leads to simpler implementations by enabling shared implementation between training and inference. Indeed, training directly optimizes the loss function output and does not require the class probabilities as direct output. On the other hand, inference requires the class probabilities which are calculated from the logits.

Thus, in a further particularly advantageous embodiment of the present invention, for unoccupied cells, the background logits may be set to an arbitrarily high value (such as 10), and other logits may be set to an arbitrarily low value (such as 0). Any high/low value combination with a sufficiently high difference is usable.

In a further advantageous embodiment of the present invention, at most 10% of the cells in the grid is occupied. That is, the grid is only sparsely occupied. If the point cloud is sparse, computing the final classification scores and/or properties of objects in the manner as presently proposed is more stable and more reliable compared with a computation without modifying the values for unoccupied grid cells. For example, a task neural network for object detection can only output bounding boxes in occupied cells. Typically, when monitoring the environment of a vehicle with a radar or lidar sensor, there are a few thousand points that pertain to objects, there are about one hundred thousand grid cells. Exemplary situations where the point cloud is particularly sparse include situations where a radar sensor outputs only a low number of points or is monitoring far-away objects.

In a further particularly advantageous embodiment of the present invention, the task neural network comprises
a feature extractor or object detector that produces feature maps or bounding boxes as intermediate grids, and
at least one classification head that further processes these intermediate grids into the output grid.

In this manner, one and the same intermediate grids may be re-used for further processing by several classification heads. For example, different classification heads may be responsible for detecting different types of objects. For example, when monitoring the environment of a vehicle, one classification head may be responsible for classifying traffic signs, whereas another classification head head may be responsible for classifying other traffic participants. Thus, the classification heads may also be termed “class heads”.

In the class heads, an additional convolutional neural network estimates an object probability between 0 and 1 and the regression parameters for an Oriented Bounding Box, OBB (position, length, width, height, orientation), for each cell of the feature maps. For the detection of different object types, several of these class heads are used, each of which is responsible for the prediction of an object type class, i.e. object types with similar properties such as trucks and buses. These class heads use characteristic maps with appropriate resolution according to the object types to be detected. For example, a feature map with a higher resolution is used for small objects such as pedestrians than for large objects such as trucks.

According to an example embodiment of the present invention, the network outputs one or more grids of object hypotheses (usually one grid per class head). For each cell, one or more object hypotheses with an object type classification, the object's position, the dimensions (length, width, height, orientation) of an OBB surrounding the object are predicted.

In a further particularly advantageous embodiment of the present invention, the measurement data comprises radar data, lidar data, and/or ultrasound data acquired using at least one sensor. These are prime examples of measurement modalities that produce sparsely populated point clouds.

In a further particularly advantageous embodiment of the present invention, the values of the at least one measurement quantity, and/or of at least one work product derived therefrom, are assigned to each cell of the input grid using a projection neural network. This produces less artifacts than directly computing the values of the measurement quantity that are to be assigned to each cell of the input grid from the points in this cell only.

The input of a grid projection module is unordered points. Its output is an n-dimensional (typically 2 or 3) regular grid covering a certain area. The resolution determines the area of each of the number of cells within the grid.

Grid projection can also be done in a multiscale manner where the input is a list of unordered points and the outputs are multiple n-dimensional regular grids. Typically, each regular grid has a correspondent grid of identical spatial dimensions in the backbone network such that they can be fused in any manner (concatenation, addition, etc.).

In a further particularly advantageous embodiment of the present invention, from the determined classification scores and/or properties of at least one object, an actuation signal is computed. A vehicle, a traffic assistance system, a robot, a surveillance system, a quality inspection system, and/or a pick-and-place manufacturing system, is actuated with the actuation signal. In this manner, there is an improved probability that the action performed by the respective actuated system in response to the actuation signal is appropriate in the situation characterized by the original measurement data.

For example, in an automated manufacturing or assembly system, based on the finally computed classification scores and/or properties, components and their orientations may be detected to determine their grip points. Vehicles and robots, such as lawnmowers, may detect, based on the finally computed classification scores and/or properties, obstacles, traffic signs, other traffic participants that have an impact on the future behavior of the vehicle or robot. The same applies mutatis mutandis to traffic assistance systems, in particular for bicycles or other two-wheel vehicles. But traffic applications are not limited to vehicle-borne sensors. Rather, traffic may also be monitored, for example, with stationary radar or lidar sensors. A surveillance system or access control system may, based on the finally computed classification scores and/or properties, detect and identify authorized persons, so that an alarm can be disabled, and/or a door can be automatically opened. Likewise, a surveillance system may also detect, classify and identify hazardous goods.

The method may be wholly or partially computer-implemented and embodied in software. The present invention therefore also relates to a computer program with machine-readable instructions that, when executed by one or more computers and/or compute instances, cause the one or more computers and/or compute instances to perform the method of the present invention described above. Herein, control units for vehicles or robots and other embedded systems that are able to execute machine-readable instructions are to be regarded as computers as well. Compute instances comprise virtual machines, containers or other execution environments that permit execution of machine-readable instructions in a cloud.

A non-transitory machine-readable data carrier, and/or a download product, may comprise the computer program of the present invention. A download product is an electronic product that may be sold online and transferred over a network for immediate fulfilment. One or more computers and/or compute instances may be equipped with said computer program, and/or with said non-transitory storage medium and/or download product.

In the following, the present invention is described using Figures without any intention to limit the scope of the present invention.

### BRIEF DESCRIPTION OF THE DRAWINGS

FIG. 1 shows an exemplary embodiment of the method 100 of the present invention for processing measurement data 3 from the surveillance of an area 1 with objects 2.

FIG. 2 shows an illustration of the occupancy masking performed in the course of the method 100.

### DETAILED DESCRIPTION OF EXAMPLE EMBODIMENTS

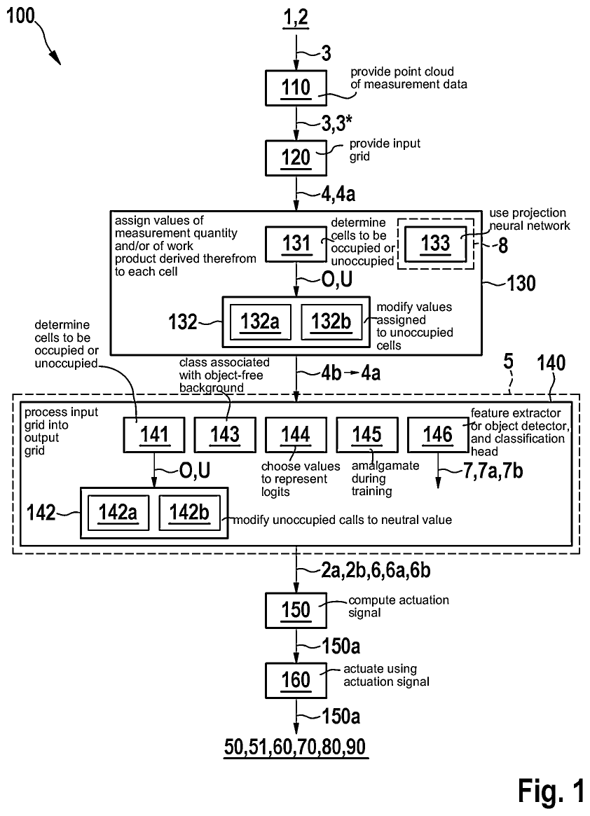

FIG. 1 is a schematic flow chart of an embodiment of the method 100 for processing measurement data 3 from the surveillance of an area 1 with objects 2. The result of this processing comprises classification scores 2a with respect to a given classification, and/or properties 2b, of objects 2 in the area 1.

In step 110, a point cloud 3* of measurement data 3 is provided. This point cloud 3* assigns, to each of a plurality of points 3a-3e in space, measurement values of at least one quantity.

In step 120, an input grid 4 with a plurality of cells 4a is provided.

In step 130, based on the point cloud 3*, values 4b of the at least one measurement quantity, and/or of at least one work product derived therefrom, are assigned to each cell 4a of the input grid 4.

In step 140, a task neural network 5 processes the input grid 4 into an output grid 6 whose cells 6a carry classification scores 2a and/or properties 2b of objects 2 as values 6b.

According to block 131 and/or 141, each cell 4a, 6a, 7a of the input grid 4, the output grid 6, and/or an intermediate grid 7 that arises during the processing of the input grid 4 into the output grid 6, is determined to be
occupied, O, by an object 2 if at least one point 3a-3e of the point cloud 3* is within this cell 4a, 6a, 7a, and
unoccupied, U, if this cell 4a, 6a, 7a is free of points 3a-3e of the point cloud 3*.

According to block 132, respectively 142, values 4b, 6b, 7b assigned to unoccupied cells 4a, 6a, 7a in the respective grid 4, 6, 7 are then modified to a neutral value in the context of the respective grid 4, 6, 7.

According to block 132a, respectively 142a, a value that pertains, in the context of the respective grid 4, 6, 7, to an object-free background may be chosen as the neutral value.

According to block 132b, respectively 142b, values 4b, 6b, 7b assigned to unoccupied cells 4a, 6a, 7a may be further modified according to values in one or more neighboring cells 4a, 6a, 7a.

According to block 133, the values 4b of the at least one measurement quantity, and/or of at least one work product derived therefrom, may be assigned to each cell of the input grid using a projection neural network 8.

According to block 143, the given classification may comprise, in addition to classes associated with objects 2, a class associated with an object-free background.

According to block 144, the values in the intermediate grid 7 and/or output grid 6 may be chosen to represent logits that are precursors for classification scores 2a.

According to block 145, during training of the task neural network 5, computation of classification scores 2a from logits may be amalgamated with computation of the value of a loss function that rates these classification scores 2a.

According to block 146, the task neural network 5 may comprise
a feature extractor or object detector 5a that produces feature maps or bounding boxes as intermediate grids 7, and
at least one classification head 5b that further processes these intermediate grids 7 into the output grid 6.

In the example shown in FIG. 1, in step 150, from the determined classification scores 2a and/or properties 2b of at least one object 2, an actuation signal 150a is computed. In step 160, a vehicle 50, a traffic assistance system 51, a robot 60, a surveillance system 70, a quality inspection system 80, and/or a pick-and-place manufacturing system 90, is then actuated with the actuation signal 150a.

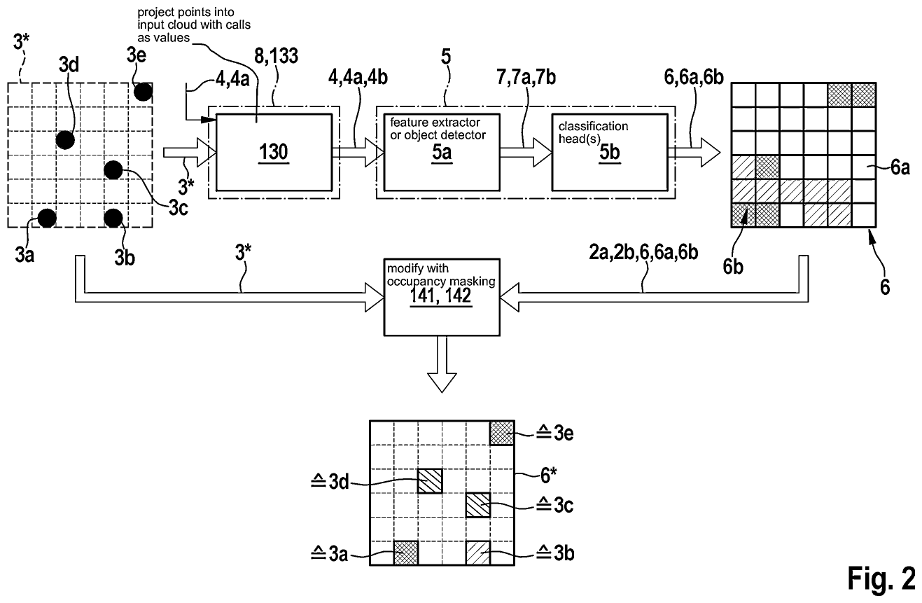

FIG. 2 illustrates the occupancy masking performed in the course of the method 100 on a simple example.

In this example, the point cloud 3* comprises five points 3a-3e. In step 130 of the method 100, these five points 3a-3e are projected into a given input cloud 4 with cells 4a as values 4b. Optionally, according to block 133 of the method 100, this step may be performed by a projection neural network 8.

The task neural network 5 comprises an object detector 5a that processes the input grid 4 into an intermediate grid 7 with cells 7a and values 7b that represent bounding boxes of objects 2. The task neural network 5 further comprises a classifier head 5b that processes the intermediate grid 7 into the output grid 6 with cells 6a and values 6b. These values 6b represent the sought classification scores 2a, and/or properties 2b, of objects 2 in the observed area 1. In the simple example shown in FIG. 2, the output grid 6 has the same spacing as the input grid 4.

In the example shown in FIG. 2, the output grid 6 is modified by occupancy masking according to blocks 141 and 142 as described above. This means that, for the positions in the output grid 6 that correspond to the points 3a to 3e, the values 6b in the output grid 6 are kept as they are. For all other positions, the values 6b are modified to neutral values in the context of the output grid 6. The modified output grid is labelled with the reference sign 6*. It only contains information on locations where, according to the original point cloud 3*, objects 2 reside.

What is claimed is:

1. A method for processing measurement data from a surveillance of an area into classification scores with respect to a given classification and/or properties of objects in the area, comprising the following steps:
providing a point cloud of measurement data that assigns, to each of a plurality of points in space, measurement values of at least one quantity;
providing an input grid with a plurality of cells;
assigning, based on the point cloud, values of the at least one measurement quantity, and/or of at least one work product derived from the values of the at least one measurement quantity, to each cell of the input grid; and
processing, by a task neural network, the input grid into an output grid whose cells carry determined classification scores and/or properties of objects as values;
wherein, for the input grid, and/or for the output grid, and/or for an intermediate grid that arises during the processing of the input grid into the output grid:
each cell is determined to be:
occupied by an object if at least one point of the point cloud is within the cell, and
unoccupied if the cell is free of points of the point cloud, and
values assigned to unoccupied cells of the input grid and/or output grid and/or intermediate grid are modified to a neutral value in a context of the input grid and/or output grid and/or intermediate grid.

2. The method of claim 1, wherein a value that pertains, in the context of the input grid and/or output grid and/or intermediate grid, to an object-free background is chosen as the neutral value.

3. The method of claim 1, wherein the given classification includes, in addition to classes associated with objects, a class associated with an object-free background.

4. The method of claim 1, wherein values assigned to unoccupied cells are further modified according to values in one or more neighboring cells.

5. The method of claim 4, wherein, in the input grid and/or output grid and/or intermediate grid:
a softening algorithm is applied to at least one boundary between a first region including occupied cells and a second region including unoccupied cells; and/or
in response to determining that a cell is occupied, neighboring cells are treated as being occupied as well.

6. The method of claim 1, wherein values in the intermediate grid and/or output grid are chosen to represent logits that are precursors for classification scores.

7. The method of claim 1, wherein, during training of the task neural network, computation of classification scores from logits is amalgamated with computation of a value of a loss function that rates the classification scores.

8. The method of claim 1, wherein at most 10% of the cells in the input grid and/or output grid and/or intermediate grid are occupied.

9. The method of claim 1, wherein the task neural network includes:
a feature extractor or object detector that produces feature maps or bounding boxes as intermediate grids, and
at least one classification head that further processes the intermediate grids into the output grid.

10. The method of claim 1, wherein the measurement data include radar data, and/or lidar data, and/or ultrasound data, acquired using at least one sensor.

11. The method of claim 1, wherein the values of the at least one measurement quantity, and/or of at least one work product derived from the values of the at least one measurement quantity, are assigned to each cell of the input grid using a projection neural network.

12. The method of claim 1, further comprising:
computing, from the determined classification scores and/or properties of at least one object, an actuation signal; and
actuating, using the actuation signal, a vehicle and/or a traffic assistance system and/or a robot and/or a surveillance system and/or a quality inspection system and/or a pick-and-place manufacturing system.

13. A non-transitory machine-readable data carrier on which are stored machine-readable instructions for processing measurement data from a surveillance of an area into classification scores with respect to a given classification and/or properties of objects in the area, the instructions, when executed by one or more computers and/or compute instances, causing the one or more computers and/or compute instances to perform the following steps:
providing a point cloud of measurement data that assigns, to each of a plurality of points in space, measurement values of at least one quantity;
providing an input grid with a plurality of cells;
assigning, based on the point cloud, values of the at least one measurement quantity, and/or of at least one work product derived from the values of the at least one measurement quantity, to each cell of the input grid; and
processing, by a task neural network, the input grid into an output grid whose cells carry determined classification scores and/or properties of objects as values;
wherein, for the input grid, and/or for the output grid, and/or for an intermediate grid that arises during the processing of the input grid into the output grid:
each cell is determined to be:
occupied by an object if at least one point of the point cloud is within the cell, and
unoccupied if the cell is free of points of the point cloud, and
values assigned to unoccupied cells of the input grid and/or output grid and/or intermediate grid are modified to a neutral value in a context of the input grid and/or output grid and/or intermediate grid.

14. One or more computers and/or compute instances with a non-transitory machine-readable data carrier on which are stored machine-readable instructions for processing measurement data from a surveillance of an area into classification scores with respect to a given classification and/or properties of objects in the area, the instructions, when executed by the one or more computers and/or compute instances, causing the one or more computers and/or compute instances to perform the following steps:
providing a point cloud of measurement data that assigns, to each of a plurality of points in space, measurement values of at least one quantity;
providing an input grid with a plurality of cells;
assigning, based on the point cloud, values of the at least one measurement quantity, and/or of at least one work product derived from the values of the at least one measurement quantity, to each cell of the input grid; and
processing, by a task neural network, the input grid into an output grid whose cells carry determined classification scores and/or properties of objects as values;
wherein, for the input grid, and/or for the output grid, and/or for an intermediate grid that arises during the processing of the input grid into the output grid:
each cell is determined to be:
occupied by an object if at least one point of the point cloud is within the cell, and
unoccupied if the cell is free of points of the point cloud, and
values assigned to unoccupied cells of the input grid and/or output grid and/or intermediate grid are modified to a neutral value in a context of the input grid and/or output grid and/or intermediate grid.
